(19) United States
(12) Patent Application Publication
(10) Pub. No.: US 2013/0307253 A1
(43) Pub. Date: Nov. 21, 2013

(54) AIRBAG COVER AND MODULE

(71) Applicants: HYUNDAI MOTOR COMPANY, Seoul (KR); KIA MOTORS CORP., Seoul (KR)

(72) Inventors: Hyo Shub SHIN, Hwaseong-si (KR); Hyeong Ho CHOI, Gwangmyeong-si (KR); Chang Hyun LEE, Yongin-si (KR); Tae In KIM, Yongin-si (KR); Jung Yeol JANG, Incheon (KR); Jae Haeng YOO, Yongin-si (KR)

(73) Assignees: Kia Motors Corp., Seoul (KR); Hyundai Motor Company, Seoul (KR)

(21) Appl. No.: 13/683,738

(22) Filed: Nov. 21, 2012

(30) Foreign Application Priority Data
May 15, 2012 (KR) 10-2012-0051250

(51) Int. Cl. B60R 21/207

(52) U.S. Cl. CPC B60R 21/207
USPC 280/728.2; 280/728.3

(57) ABSTRACT

An airbag cover includes a housing section which forms an upper part of which is opened and into which a folded airbag cushion is housed; and a guide section which is formed by extending an upper rear end and both ends of the opened housing section to form an additional space for extending a space of the housing section and a front surface of which at a passenger side is opened to guide an initial deployment direction of the airbag cushion toward a passenger side.

### CROSS-REFERENCE TO RELATED APPLICATION

The present application claims priority of Korean Patent Application Number 10-2012-0051250 filed May 15, 2012, the entire contents of which application is incorporated herein for all purposes by this reference.

### BACKGROUND OF INVENTION

1. Field of Invention

The present invention relates to an airbag cover and module in which cushion is guided to be deployed initially further toward a passenger side while an airbag is deployed and thus the passenger cannot be collided with other components of a vehicle.

2. Description of Related Art

The present invention relates to a cover for packaging cushion of an airbag in a vehicle, and more particularly, it relates to an airbag cover and module that is arranged inside a crash pad in a passenger seat.

FIG. 1 shows an airbag cover according to a related art wherein the cover 10 is configured as a box form an upper part of which is opened simply, and an airbag cushion is packaged in an inside space 12 thereof in a folded state and the air bag cover is arranged inside an crash pad.

FIG. 2 is a cross-sectional view showing the airbag cover shown in FIG. 1 wherein the packaged cushion C and cover 10 are arranged inside the crash pad P and the cushion is inflated to get out of the cover and then tear a tear line of the crash pad to be expanded upward while an inflator explodes.

At this time, a rapid deployment speed of the cushion is important for prompt management while a vehicle collides, and as a result the inflator is designed generally to increase explosion capacity thereof.

However, even though the explosion capacity of the airbag cushion is increased in proportion to the increasing of the deployment speed, specially in case of the airbag arranged on a passenger seat, there is a problem in that the cushion is inflated while tearing an airbag door that is formed on the crash pad, and the wind shield glass W is impacted from the inflation force to be damaged.

Accordingly, there is a need of technology to prevent in advance the wind shield glass W from being struck and broken while the airbag arranged on a passenger seat is deployed and the airbag cushion is inflated upward rapidly at an initial state, thereby protecting surely the passenger on a passenger seat.

The matters described as the above-mentioned background art are only to improve understanding of the background of the present invention and should not be construed as being recognized as the related art which is already known to those of ordinary skill in the art.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an airbag cover and module, capable of preventing in advance the wind shield glass W from being struck and broken while the airbag arranged on a passenger seat is deployed and the airbag cushion is inflated upward rapidly at an initial state, thereby protecting surely the passenger on a passenger seat.

Various aspects of the present invention provide for an airbag cover including a housing section which is a box form an upper part of which is opened and into which a folded airbag cushion is housed; and a guide section which is formed by extending an upper rear end and both ends of the opened housing section to form an additional space for extending a space of the housing section and a front surface of which at a passenger side is opened to guide an initial deployment direction of the airbag cushion toward a passenger side.

The guide section may be configured as a box form for covering the upper end of the housing section and forming a space extended from the housing section.

An upper surface of the guide section may be extended further toward a passenger side than the lower end.

The both side surfaces of the guide section may form a trapezoid shape wherein the upper end is an upper side and the lower end is a lower side thereof.

The guide section may be configured as a box form for covering the upper end of the housing section and forms the space extended from the housing section, and the upper surface thereof may be extended toward a passenger side and the both side surfaces form a trapezoid shape wherein the upper end is an upper side and the lower end is a lower side thereof, and the front surface at a passenger side is opened.

An extending section extended toward a passenger side may be formed on a front end of the upper ends of the housing section so that the airbag cushion is not interrupted with a vehicle panel when the airbag cushion is deployed.

The airbag cover may be an airbag cover of a passenger seat that is arranged inside a crash pad of a passenger seat.

Various aspects of the present invention provide for an airbag module including a housing section an upper end of which is opened and into which an airbag cushion is housed, and a guide section that is extended at an upper end of the housing section to form an additional space wherein the front surface thereof is opened to guide the initial deployment direction of the airbag cushion toward a passenger side; an inflator connection section provided on a lower surface of the housing section; and a diffuser that covers the inflator connection section at inner space of the housing section and distributes gas left-right ward.

A height of the diffuser may be 0.4-0.6 times as tall as the height of the airbag cover.

The diffuser may be configured as a tunnel form extended left-rightward wherein both side ends thereof are opened and thus the gas is supplied left-rightward through the opened side ends while gas is supplied initially.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an airbag cover according to a related art.

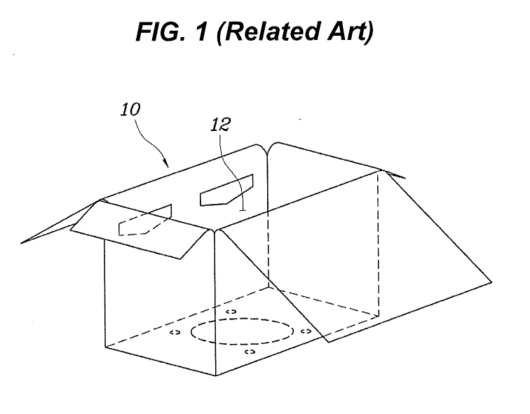

FIG. 2 is a cross-sectional view showing the airbag cover shown in FIG. 1.

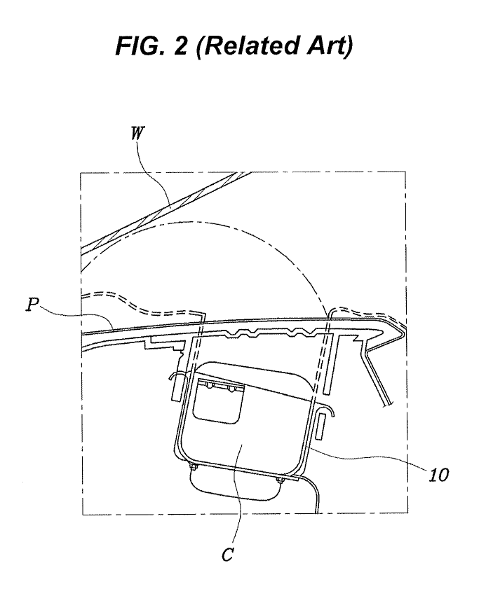

FIG. 3 is a view showing an exemplary airbag cover according to the present invention.

FIG. 4 is a cross-sectional view showing the airbag cover shown in FIG. 3.

FIG. 5 is a view showing a diffuser of an exemplary airbag module according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

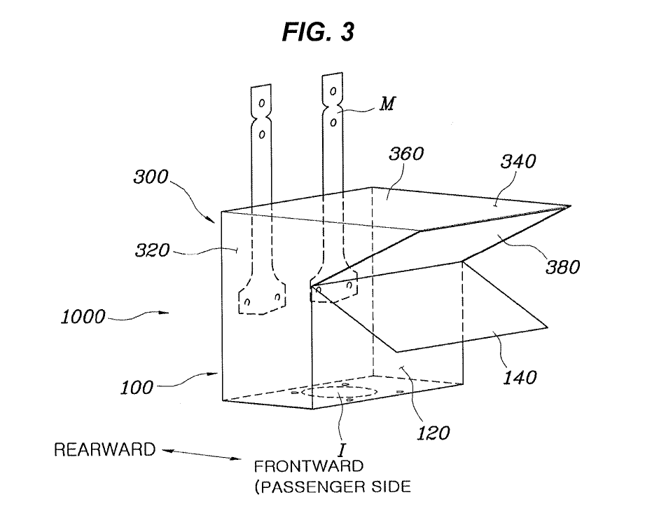

FIG. 3 is a view showing an airbag cover according to various embodiments of the present invention wherein the airbag cover includes: a housing section 100 which is configured as a box form an upper part of which is opened and into which a folded airbag cushion is housed; and a guide section 300 which is formed by extending an upper rear end and both ends of the opened housing section 100 to form an additional space 320 for extending a space 120 of the housing section and a front surface of which at a passenger side is opened to guide an initial deployment direction of the airbag cushion toward a passenger side.

The housing section 100 of the airbag cover 1000 according to various embodiments of the present invention may be configured as the same way as the related art. That is, the airbag cushion may be folded and packaged in the inner space 120 of the box form an upper part of which is opened. However, when the cover shape is kept in that form, the cushion is inflated rightly upward as the same way as the related art so that upward deployment force becomes strong, and thus the guide section 300 is extended at an upper end of the housing section 100 to guide the initial deployment direction toward the passenger side, instead of an upward direction.

For this purpose, the guide section 300 is extended to the upper rear end and both ends of the opened housing section 100 to form the additional space 320 and thus the space 120 of the housing section is extended wherein a front surface of the space at a passenger side is opened to guide the initial deployment direction of the airbag cushion toward the passenger side.

In more detailed description, the guide section 300 is extended further at the opened upper end of the housing section 100 to form the additional space that is opened toward a passenger side, and thus the airbag cushion is guided to be deployed initially toward a passenger side. That is, the airbag cushion is inflated gradually along the space 120 of the housing section 100 and the space 320 of the guide section 300 while it is inflated by explosion of an inflator, and the airbag cushion is inflated finally outside through a front opening 380 of the guide section 300.

Accordingly, the airbag cushion is first deployed frontward instead of being deployed rightly upward not to apply direct impact on upper wind shield glass.

Further, an edge of a side surface 360 of the guide section 300 may be enforced additionally as a twofold by sewing in order to prevent the side surface 360 of the guide section 300 from being torn.

Meanwhile, as shown in FIG. 3, the guide section 300 is configured as a box form covering the upper end of the housing section 100 to form a space 320 extended from the housing section 100. Further, the upper surface 340 of the guide section 300 may be further extended toward a passenger side than the lower end thereof. As a result, the both side surfaces 360 of the guide section 300 may be a trapezoid form wherein the upper end is an upper side and the lower end is a lower side.

That is, the guide section 300 is entirely a box form covering the upper end of the housing section 100 to form the space 320 extended from the housing section 100, and further the upper surface 340 is extended toward to a passenger side and the both side surfaces 360 form a trapezoid form wherein the upper end is an upper side and the lower end is a lower side, and the front surface 380 at a passenger side is opened.

The airbag cushion starts to be deployed along inner space of the housing section 100 and the guide section 300 and is deployed toward a passenger side through the front opening 380 of the guide section 300 wherein as the airbag cushion is inflated further, the guide section 300 retracts rearward gradually.

That is, in an initial deployment state, the guide section 300 is a box form at inner part of which the airbag is defined, however, as the airbag cushion increases in its volume and is inflated further frontward, the guide section 300 cannot house the airbag cushion due to the inflation of the airbag cushion and thus is taken off rearward.

Accordingly, the guide section 300 serves to guide only the deployment direction of the airbag cushion toward a passenger side instead of upward at an initial state, and in case where the airbag cushion is inflated further, it is taken off rearward not to hinder the deployment of the airbag cushion.

For this purpose, the upper surface 340 of the guide section 300 is extended toward a passenger side, as shown in FIG. 3, the both side surfaces 360 form a trapezoid form wherein the upper end is an upper side and the lower end is a lower side, and the front surface 380 toward a passenger side is opened, and thus the airbag cushion is restricted to the passenger side in an initial state through the extended upper surface. Here, when the airbag cushion is deployed further by the longer upper side of the trapezoid, the guide section 300 can be taken off rearward easily.

The form of the guide section 300 as described above can restrict efficiently the deployment direction of the airbag cushion in an initial state and further can be taken off easily not to extend excessively the whole deployment time period.

Meanwhile, an extending section 140 that is extended toward a passenger side is formed on a front end among the upper ends of the housing section 100 for the airbag cushion not to be interfered with a vehicle panel while the airbag cushion is deployed. That is, the airbag cushion is not to be caught on the vehicle panel adjacent to an airbag door of the crash pad P while the airbag cushion is deployed so that the airbag cushion can be deployed efficiently and stably.

Meanwhile, when the airbag cover 1000 is an airbag cover that is arranged inside the crash pad P of the passenger seat, the wind shield glass can be avoided efficiently from being struck and broken by the inflated cover.

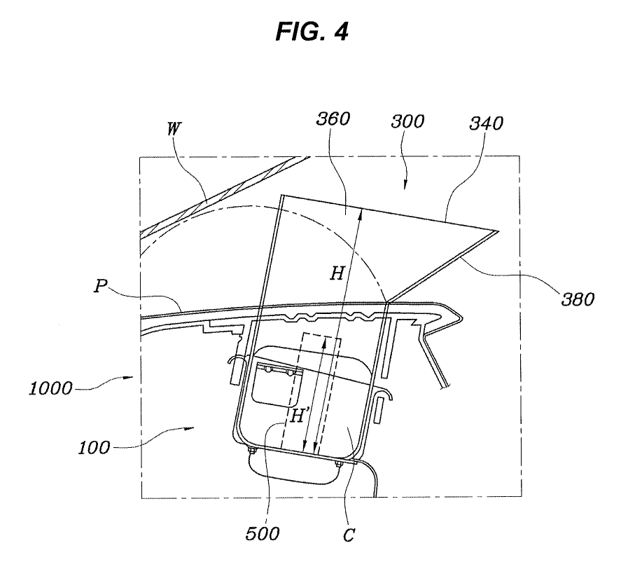

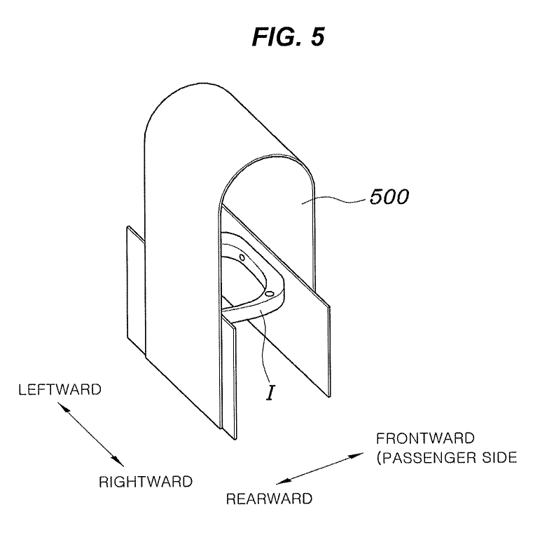

Meanwhile, FIG. 4 is a cross-sectional view showing the airbag cover shown in FIG. 3, and FIG. 5 is a view showing a diffuser of an airbag module according to various embodiments of the present invention.

The airbag module according to various embodiments of the present invention includes: an airbag cover 1000 including a housing section 100 an upper end of which is opened and into which an airbag cushion is housed, and a guide section 300 that is extended at an upper end of the housing section 100 to form an additional space 320 wherein the front surface 380 thereof is opened to guide the initial deployment direction of the airbag cushion toward a passenger side; an inflator connection section I provided on a lower surface of the housing section 100; and a diffuser 500 that covers the inflator connection section I at inner space of the housing section 100 and distributes gas left-right ward.

The airbag module is arranged at an inner side of the crash pad and includes the airbag cover and the inflator connection section I that is formed on a lower surface of the inner space of the airbag cover.

Further, the diffuser is provided over the inflator connection section and it covers the inflator connection section I in internal space of the housing section 100 and serves to distribute gas left-rightward. According to the airbag cushion and module, a height H′ of the diffuser 500 may be 0.4-0.6 times as tall as the height H of the airbag cover since when the diffuser 500 is very low, the gas is not effused efficiently and the diffuser is broken, and when the diffuser is too high, the gas is not distributed left-rightward efficiently, and thus it is not easy to restrict the upward deployment force by gas.

Accordingly, the height H′ of the diffuser 500 is 0.4-0.6 times as tall as the height H of the airbag cover and thus it is possible to maintain proper gas effusing force and restrict the initial deployment direction of the airbag cushion. The proportion of the heights is deduced from experiment and the same proportion may be applied to various vehicles.

Meanwhile, the diffuser 500 is configured as a tunnel form extended left-rightward wherein both side ends thereof are opened and thus the gas is supplied left-rightward through the opened side ends while gas is supplied initially.

As shown in FIG. 4, when the airbag is deployed, according to the airbag cover of the present invention, the airbag is restricted to be deployed frontward toward a passenger side by the guide section 300 while the airbag cushion is deployed initially. Further, this restriction is possible since the height of the diffuser 500 is limited and thus strong inflation force is not applied upward while having proper distribution force.

According to the airbag cover and the airbag module as configured above, other components in a vehicle are avoided being struck and broken in advance when the airbag is deployed initially.

Specially, in case of the airbag in a passenger seat, the wind shield glass can be avoided being struck and broken in advance by the upward deployment of the airbag cushion.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An airbag cover, comprising: a housing section forming an enclosure including an upper part of which is opened and into which a folded airbag cushion is housed; and a guide section formed by extending an upper rear end and opposing side ends of the housing section to form an additional space for extending a space of the housing section and a front surface of which at a passenger side is opened to guide an initial deployment direction of the airbag cushion toward a passenger side.

2. The airbag cover of claim 1, wherein the guide section covers the upper end of the housing section and forms a space extended from the housing section.

3. The airbag cover of claim 1, wherein an upper surface of the guide section is extended further toward a passenger side than the lower end.

4. The airbag cover of claim 3, wherein the both side surfaces of the guide section form a trapezoid shape wherein the upper end is an upper side and the lower end is a lower side thereof.

5. The airbag cover of claim 1, wherein the guide section covers the upper end of the housing section and forms the space extended from the housing section, and the upper surface thereof is extended toward a passenger side and the both side surfaces form a trapezoid shape wherein the upper end is an upper side and the lower end is a lower side thereof, and the front surface at a passenger side is opened.

6. The airbag cover of claim 1, wherein an extending section extended toward a passenger side is formed on a front end of the upper ends of the housing section so that the airbag cushion is not interrupted with a vehicle panel when the airbag cushion is deployed.

7. The airbag cover of claim 1, wherein the airbag cover is an airbag cover of a passenger seat that is arranged inside a crash pad of a passenger seat.

8. An airbag module, comprising:
a housing section including an upper end of which is opened and into which an airbag cushion is housed, and a guide section that is extended at an upper end of the housing section to form an additional space wherein the front surface thereof is opened to guide the initial deployment direction of the airbag cushion toward a passenger side;
an inflator connection section provided on a lower surface of the housing section; and a diffuser that covers the inflator connection section at inner space of the housing section and distributes gas left-right ward.

9. The airbag module of claim 8, wherein a height of the diffuser is 0.4-0.6 times as tall as the height of the airbag cover.

10. The airbag module of claim 8, wherein the diffuser is configured as a tunnel form extended left-rightward wherein both side ends thereof are opened and thus the gas is supplied left-rightward through the opened side ends while gas is supplied initially.
